(19) United States
(12) Patent Application Publication
(10) Pub. No.: US 2017/0223589 A1
(43) Pub. Date: Aug. 3, 2017

(54) Managing Data Reception Following a Tune-Away

(71) Applicant: QUALCOMM Incorporated, San Diego, CA (US)

(72) Inventors: Kuo-Chun Lee, San Diego, CA (US); Levent Aydin, San Diego, CA (US); Sivaramakrishna Veerepalli, San Diego, CA (US); Reza Shahidi, San Diego, CA (US); Wenshu Zhang, San Diego, CA (US); Jack Shyh-Hurng Shauh, San Diego, CA (US); Pavan Chaithanya Kaivaram, San Diego, CA (US); Ramchandran Srinivasan, San Diego, CA (US); Vivek Padi, San Diego, CA (US); Muhammed Sarwar, Poway, CA (US)

(21) Appl. No.: 15/012,127

(22) Filed: Feb. 1, 2016

(51) Int. Cl. H04W 36/14; H04W 36/00; H04W 8/18

(52) U.S. Cl. CPC H04W 36/14; H04W 8/183; H04W 36/0011

(57) ABSTRACT

Various embodiments include multi-subscription multi-standby (MSMS) communication devices and methods for managing reception of data using a first subscription following a tune-away by a radio frequency (RF) resource chain from the first subscription to a second subscription. In various embodiments the MSMS communication device may receive data over the first subscription during a warm-up period of the RF resource chain following completion of the tune-away. In some embodiments, the device processor may receive the data over the first subscription during the warm-up period using one or more channel parameters of the first subscription determined before the tune-away. In some embodiments, the device processor may receive data over the first subscription during the warm-up period using one or more channel parameters of the first subscription determined initially during the warm-up period.

### BACKGROUND

A multi-subscription multi-standby communication device may include one or more Subscriber Identity Module (SIM) cards that provide users with access to multiple separate mobile telephony networks. Each SIM may be associated with a different service provider subscription, enabling the multi-subscription multi-standby communication device to communicate with one or more communication networks. Each SIM or subscription may also be associated with a radio access technology (RAT).

A multi-subscription communication device that includes one or more SIMs and connects to two or more separate mobile telephony networks using one or more shared radio frequency (RF) resources/radios may be termed a “multi-standby” communication device. One example of a multi-subscription multi-standby communication device is a dual-SIM-dual-standby (DSDS) communication device, which includes two SIM cards that share a set of radio frequency (RF) circuitry (referred to as an “RF resource chain”) to communicate with two separate mobile telephony networks on behalf of their respective subscriptions. Another example is a single-radio LTE (SRLTE) communication device, which includes one SIM card/subscription associated with two (or more) subscriptions that share a single shared RF resource chain to communicate with one or more multi-subscription multi-standby communication networks on behalf of the multiple subscriptions.

At certain times the multiple RATs sharing the RF resource chain may need to use the RF resource chain to communicate with their respective mobile networks simultaneously. Therefore, the communication device periodically forces one RAT to interrupt its RF operations so that the other RAT can use the shared RF resource chain to perform communication operations. This process is called a “tune-away,” since the RF resource chain must tune away from the frequency bands and/or channels of the first RAT and must tune to frequency bands/channels of the second RAT. As a result of the tune-away event, data received using the active RAT may be lost or corrupted and thus difficult or impossible to decode.

The problem of data loss during a tune-away may be exacerbated when the first RAT is conducting communications that are particularly sensitive to latency or data loss, such as streaming media, for example, eMBMS (Evolved Multimedia Broadcast Multicast Service).

### SUMMARY

Various embodiments include methods and multi-subscription multi-standby (MSMS) communication devices implementing methods for managing reception of data on a first subscription following a tune-away of a radio frequency (RF) resource chain from the first subscription to a second subscription. Various methods may include receiving data over the first subscription during a warm-up period following tuning of the RF resource chain from the second subscription to the first subscription. Some embodiments may further include determining one or more channel parameters of the first subscription before the tune-away from the first subscription to the second subscription, and receiving data over the first subscription during the warm-up period following tuning of the RF resource chain from the second subscription to the first subscription may include determining whether the MSMS communication device is receiving data on the first subscription after tuning the RF resource chain from the second subscription to the first subscription, and receiving data over the first subscription during the warm-up period using the one or more channel parameters of the first subscription determined before the tune-away in response to determining that the MSMS communication device is receiving data on the first subscription after the tune-away.

Some embodiments may further include suspending uplink transmissions during the warm-up period. Some embodiments may further include determining one or more channel parameters of the first subscription before the tune-away from the first subscription to the second subscription, and receiving data over the first subscription during a warm-up period following tuning of the RF resource chain from the second subscription to the first subscription may include receiving data over the first subscription during the warm-up period using the one or more channel parameters of the first subscription determined before the tune-away from the first subscription to the second subscription.

Some embodiments may further include determining one or more channel parameters of the first subscription during the warm-up period, determining whether the warm-up period is complete, continuing receiving data over the first subscription during the warm-up period using the one or more channel parameters of the first subscription determined before the tune-away from the first subscription to the second subscription in response to determining that the warm-up period is not complete, and conducting communications over the first subscription using the one or more channel parameters of the first subscription determined during the warm-up period. Such embodiments may further include performing an initial determination of one or more channel parameters of the first subscription during the warm-up period, and receiving data over the first subscription during a warm-up period following tuning of the RF resource chain from the second subscription to the first subscription may include receiving data over the first subscription during the warm-up period using the initially determined one or more channel parameters of the first subscription. Such embodiments may further include determining whether the MSMS communication device is receiving data on the first subscription following the tune-away, wherein performing the initial determination of one or more channel parameters of the first subscription during the tune-away from the first subscription to the second subscription is performed in response to determining that the MSMS communication device is not receiving data on the first subscription following the tune-away.

Some embodiments may further include refining the initially determined one or more channel parameters of the first subscription during the warm-up period. Such embodiments may further include determining whether the warm-up period is complete, continuing receiving data over the first subscription during the warm-up period using the initially determined one or more channel parameters of the first subscription in response to determining that the warm-up period is not complete, and conducting communications over the first subscription using the refined one or more channel parameters of the first subscription in response to determining that the warm-up period is complete.

Various embodiments further include a MSMS computing device having a memory, a radio frequency (RF) resource chain, and a processor coupled to the memory and the RF resource chain and configured with processor executable instructions to perform operations of the methods described above. Various embodiments include a MSMS computing device having means for performing functions of the methods described above. Various embodiments include a non-transitory processor-readable storage medium having stored thereon processor-executable instructions configured to cause a processor of a MSMS computing device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of various embodiments, and not to limit various embodiments.

FIG. 1 is a component block diagram of a communication system suitable for use with various embodiments.

FIG. 2 is a component block diagram of a multi-subscription multi-standby communication device according to various embodiments.

FIG. 3 is a timeline illustrating a reception of data by an RF resource chain of a multi-subscription multi-standby communication device according to various embodiments.

FIG. 4 is process flow diagram illustrating a method for managing reception of data using a first subscription following a tune-away by a radio frequency (RF) resource chain of a multi-subscription multi-standby communication device from the first subscription to a second subscription according to various embodiments.

FIG. 5 is a component block diagram of a multi-subscription multi-standby communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented on multi-subscription multi-standby communication devices that improve data throughput of an active communication session on a first network associated with a first subscription when a tune-away by a shared radio frequency (RF) resource chain is performed to a second network supporting a second subscription by receiving data over the first subscription during a warm-up period of the RF resource chain following completion of the tune-away.

The terms “multi-subscription multi-standby communication device” and “MSMS communication device” refer to any one or all of cellular telephones, smartphones, laptop computers, tablet computers, smartbooks, palmtop computers, wireless electronic mail receivers, multimedia Internet enabled cellular telephones, wireless gaming controllers, and similar electronic devices and portable computing platforms which include a programmable processor, a memory, and one or more shared RF resource chains that are configured to support communications over two or more subscriptions. Various embodiments may be particularly useful in any communication devices that can support multiple wireless wide area network subscriptions and communication sessions with two or more communication networks.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network” and “second subscription” are arbitrary and are used to refer to two or more subscriptions/networks generally because at any given time either subscription/network may be in an active mode (on an active voice or data call) or a standby mode. For example, at a first time, a first subscription with a first network may be on an active data call (and thus a “first subscription) while a second subscription with a second network is in the standby mode (and thus a “second” subscription), and at a second time, the second subscription may enter an active data call (becoming the “first” subscription) and the first subscription may enter the standby mode (becoming the “second” subscription). Also, references to “first” and “second” subscriptions and networks is not intended to imply that the embodiments are limited to two subscriptions sharing one RF resource, because three or more subscriptions may share one RF resource chain provided that only one subscription can use the RF resource chain at a time. Third and fourth subscriptions would behave similar to a second subscription. Therefore, in the interest of brevity, operations of subscriptions in the standby mode that share the RF resource chain during tune-away periods are described generally with reference to the “second” subscription.

In multi-subscription multi-standby communication devices, only one subscription may use each RF resource chain to communicate with its communication network at a time. Even when a subscription is in an idle mode or a standby mode, meaning the subscription is not actively communicating with the network, the subscription may still need to periodically receive access to a shared RF resource chain in order to perform various network operations. For example, an idle subscription may need the shared RF resource chain at regular intervals to perform idle mode operations, to receive network-paging messages in order to remain connected to the network, etc. on behalf of its subscription. Therefore, it is possible that at certain times the multiple subscriptions sharing an RF resource chain will need to use the RF resource chain to communicate with their respective mobile networks simultaneously.

The MSMS communication device may force a subscription that is actively using a shared RF resource chain to interrupt its RF operations so that an idle subscription may use the shared RF resource chain to perform idle-standby mode operations. This process of switching access of the shared RF resource chain from the active subscription to the idle subscription is sometimes referred to as a “tune-away” or a “tune-away event,” as the RF resource chain must tune away from the frequency bands and/or channels of the active subscription and tune to frequency bands/channels of the idle subscription. After network communications via the idle subscription are complete, the communication device may tune the RF resource chain back from the idle subscription to the active subscription. Examples of idle-standby mode operations may include one or more of page monitoring (e.g., discontinuous reception), system information monitoring (e.g., receiving and decoding a broadcast control channel), cell reselection measurements to determine whether to initiate reselection operations to a neighboring cell, updating the second subscription network with the current location of the multi-standby communication device, receiving Short Message Service (SMS) messages, and receiving mobile-terminated calls (sometimes collectively referred to herein as tune-away operations).

As a result of the tune-away, communication activities using a first subscription are interrupted and data from the active subscription may be lost or corrupted, and thus may be difficult or impossible to decode. The tune-away may thus decrease the throughput of communications between the multi-subscription multi-standby communication device and the communication network of the active subscription, and may degrade the quality of an active communication session over the communication network. The problem of data loss during a tune-away may also impact the user experience when the first subscription is conducting communications that are particularly sensitive to latency or data loss, such as streaming media (e.g., video and audio data segments), via multi-media broadcast multicast services (such as the Evolved Multimedia Broadcast Multicast Service (eMBMS)).

After performing a tune-away to a signal of the second subscription, the MSMS communication device may require a “warm-up period” (e.g., of approximately 10-30 ms) to acquire new, more accurate frequency, timing, and/or channel estimation information that is needed to re-acquire a signal of the first subscription. The MSMS communication device may lose or otherwise be unable to decode data transmitted over the first subscription during the warm-up period. The warmup-period adds to the duration that the first subscription does not receive data during a tune-away to the second subscription.

Various embodiments enable a processor of a multi-subscription multi-standby communication device to receive more data during a tune-away event by receiving broadcast data on a first subscription during a warm-up time period after performing a tune-away from the first subscription to a second subscription.

In some embodiments, prior to a tune-away, the MSMS communication device may determine one or more channel parameters of the first subscription required to receive broadcast data using a first subscription. Channel parameters may include one or more of frequency information, timing information, and channel estimation information for a signal of the first subscription. Channel parameters can change over time.

In various embodiments, the MSMS communication device may use the stored one or more channel parameters of the first subscription to begin receiving data over the first subscription during the warm-up period following tune-back of the shared RF frequency at the completion of a tune-away. Receiving at least some data during the warm-up period may mitigate data loss during the warm-up period by effectively reducing the amount of data that the first subscription does not receive while the shared RF resource is performing the tune-away. Although the old first subscription channel parameter(s) (i.e., determined before performing the tune-away) may be somewhat inaccurate, the MSMS communication device may use the old channel parameter(s) to receive at least some broadcast data over the first subscription.

In some embodiments, the MSMS communication device may perform a quick estimation of new channel parameters of the first subscription during the warm-up period (i.e., before the warm-up period is complete), and use the quickly estimated new channel parameters to receive at least some broadcast data over the first subscription. In some instances, the MSMS communication device may tune the RF resource chain back to the first subscription in the middle of a broadcast data burst, such as prior to the start of a broadcast data burst (i.e., the data burst may begin during the warm-up period). In such cases, the MSMS communication device may use the quickly estimated channel parameter(s) to receive at least some of the broadcast data.

In various embodiments, the MSMS communication device may use old or quickly estimated channel parameter(s) to receive multicast broadcast data and/or unicast broadcast data, as well as non-traffic data, such as system information block (SIB) messages or paging messages, during the warm-up period.

In some embodiments, the MSMS communication device may continue to perform warm-up period activities while receiving data over the first subscription during the warm-up period. Warm-up period activities may include, for example, acquiring information from a control channel of the signal of the first subscription to determine more accurate channel parameter(s). In some embodiments, the MSMS communication device may perform an initial determination of one or more channel parameters of the first subscription during the warm-up period. The MSMS communication device may then receive data over the first subscription using the initially determined channel parameter(s), and perform one or more refining determinations of the channel parameter(s) while receiving data over the first subscription.

In some embodiments, the MSMS communication device may suspend one or more uplink transmissions during the warm-up period to avoid providing inaccurate channel parameter information to the network, for example, old and/or initially determined frequency, timing, and/or channel estimation information of the first subscription. The MSMS communication device may suspend the one or more uplink transmissions to avoid causing interference with other mobile communication devices based on the old and/or initially determined (i.e., less-accurate) channel parameter(s).

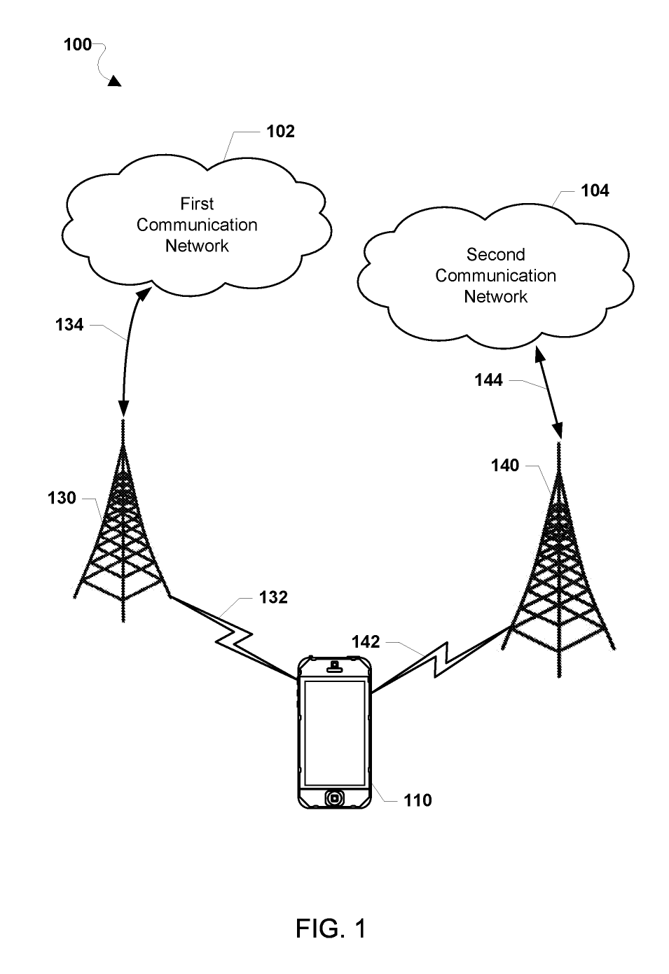

Various embodiments may be implemented in multi-subscription multi-standby communication devices that may operate within a variety of communication systems particularly systems that include two or more communication networks. FIG. 1 illustrates a communication system 100 suitable for use with various embodiments. A multi-subscription multi-standby communication device 110 may communicate with the first communication network 102 through a communication link 132 to the first base station 130. The MSMS communication device 110 may also communicate with the second mobile network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134 and 144 may include fiber optic backhaul links, microwave backhaul links, and other similar communication links.

Each of the communication networks 102 and 104 may support communications using one or more RATs, and each of the wireless communication links 132 and 142 may include cellular connections that may be made through two-way wireless communication links using one or more RATs. Examples of RATs may include 3GPP Long Term Evolution (LTE), Global System for Mobility (GSM), Worldwide Interoperability for Microwave Access (WiMAX), Code Division Multiple Access (CDMA), WCDMA, Time Division Multiple Access (TDMA), Single-Carrier Radio Transmission Technology (1xRTT), Evolution-Data Optimized (EV-DO), and other RATs. While the communication links 132 and 142 are illustrated as single links, each of the communication links may include a plurality of frequencies or frequency bands, each of which may include a plurality of logical channels. Additionally, each of the communication links 132 and 142 may utilize more than one RAT.

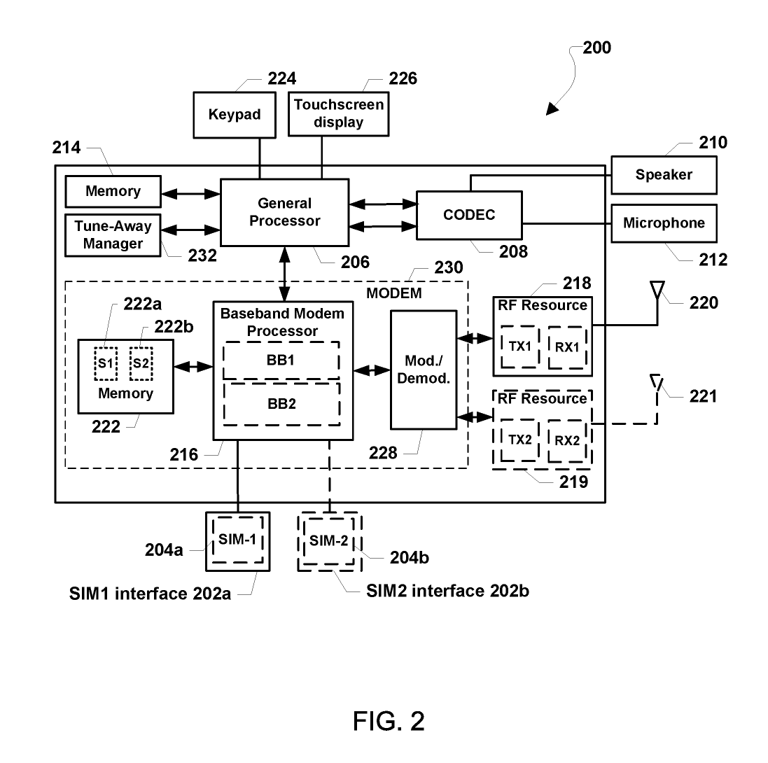

FIG. 2 is a component block diagram of a multi-subscription multi-standby communication device 200 suitable for implementing various embodiments. With reference to FIGS. 1 and 2, in various embodiments, the MSMS communication device 200 may be similar to the multi-subscription multi-standby communication device 110. The MSMS communication device 200 may include a first SIM interface 202a, which may receive a first identity module SIM-1 204a that may be associated with a first subscription. The MSMS communication device 200 may optionally also include a second SIM interface 202b, which may receive a second identity module SIM-2 204b that may be associated with a second subscription.

A SIM in various embodiments may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The MSMS communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to the RF resource chain 218 for transmission. The modulator/demodulator 228 may also extract an information-bearing signal from a modulated carrier wave received from the RF resource chain 218, and may provide the demodulated signal to the baseband modem processor 216. The modulator/demodulator 228 may be or include a digital signal processor (DSP).

In some optional embodiments, the MSMS communication device 200 may include an optional RF resource chain 219 configured similarly to the RF resource chain 218 and coupled to an optional wireless antenna 221. In such embodiments, the MSMS communication device 200 may leverage the multiple RF resource chains 218, 219 and antennae 220, 221 to perform diversity receiver reception during a tune-away event.

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the MSMS communication device 200 (e.g., SIM-1 204a, SIM-2 204b) may be coupled to the modem 230 and may be associated with or permitted to use an RF resource chain. The term “RF resource chain” may be used to refer to all of the circuitry used to send and/or receive RF signals, which may include the baseband modem processor 216 that performs baseband/modem functions for communicating with/controlling a RAT, one or more radio units including transmitter and receiver components that are shown as RF resource chain 218, and optional RF resource chain 219, one or more of the wireless antenna 220 and the optional wireless antenna 221, and additional circuitry that may include one or more amplifiers and radios. In some embodiments, an RF resource chain may share a common baseband modem processor 216 (i.e., a single device that performs baseband/modem functions for all RATs on the MSMS communication device). In some embodiments, each RF resource chain may include the physically or logically separate baseband processors (e.g., BB1, BB2).

The RF resource chains 218, 219 may include transceivers associated with one or more RATs and may perform transmit/receive functions for the MSMS communication device on behalf of their respective RATs. The RF resource chains 218, 219 may include separate transmit and receive circuitry. In some embodiments, the RF resource chain 218 may include only receive circuitry. The RF resource chains 218, 219 may each be coupled to a wireless antenna (e.g., the first wireless antenna 220 and the second wireless antenna 221). The RF resource chains 218, 219 may also be coupled to the modem 230 (e.g., via the modulator/demodulator 228, the baseband modem processor 216, or another component).

In some embodiments, the general-purpose processor 206, memory 214, baseband processor(s) 216, and the RF resource chains 218, 219 may be included in the multi-subscription multi-standby communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the multi-subscription multi-standby communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the MSMS communication device 200 to enable communication between them.

Functioning together, the two SIMs 204a, 204b, the baseband processor(s) 216, RF resource chains 218, 219, and the antennas 220, 221 may enable communications on two or more RATs. For example, one SIM, baseband processor, and RF resource chain may be configured to support two different RATs. In some embodiments, more RATs may be supported on the MSMS communication device 200 by adding more SIM cards, SIM interfaces, RF resource chains, and antennas for connecting to additional mobile networks.

The MSMS communication device 200 may optionally include a tune-away management unit 232 configured to manage the respective access of subscriptions associated with the first and second SIMs 204a, 204b to the RF resource chain 218 (and optionally the RF resource chain 219) in anticipation of or during a tune-away event. In some embodiments, the tune-away management unit 232 may tune an RF resource chain of the MSMS communication device 200 from a first subscription to a second subscription, or from the second subscription to the first subscription. In some embodiments, the tune-away management unit 232 may be implemented within the general-purpose processor 206. In other embodiments, the tune-away management unit 232 may be implemented as a separate hardware component (i.e., separate from the general-purpose processor 206). In some embodiments, the tune-away management unit 232 may be implemented as a software application stored within the memory 214 and executed by the general-purpose processor 206

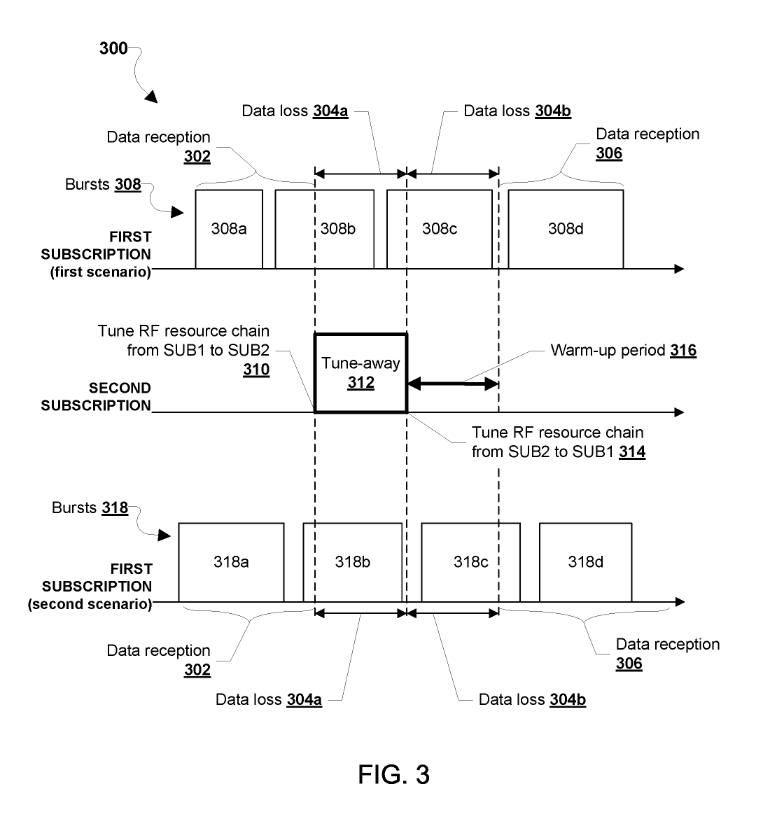

FIG. 3 illustrates a timeline 300 of a reception of data by an RF resource chain of a multi-subscription multi-standby communication device (e.g., the MSMS communication device 110, 200 of FIGS. 1 and 2) according to some embodiments. With reference to FIGS. 1-3, the MSMS communication device may conduct communications using a first subscription. For example, the MSMS communication device may receive data 302, such as a broadcast data stream, using the first subscription.

In some embodiments, a media file may be divided into portions for transport to the MSMS communication device. For example, in the Dynamic Adaptive Streaming over HTTP (DASH) protocol, the media file may be divided into segments. Each segment may be sent to the MSMS communication device in one or more bursts (e.g., data bursts). For example, in a first scenario, the MSMS communication device may receive a segment over the first subscription in bursts 308, including bursts 308a, 308b, 308c, and 308d. As another example, in a second scenario, the MSMS communication device may receive segment over the first subscription in bursts 318, including bursts 318a, 318b, 318c, and 318d.

In some embodiments, the MSMS communication device may also receive scheduling information for the data, for example, multicast traffic channel scheduling information (MSI). The scheduling information may include information about the content of each burst, such as an allocation of information in each subframe of the burst (e.g., which subframes include media data and/or error correction data), timing information about the burst (e.g., a beginning and an end of each burst), and other burst information. Following the scheduling information, the MSMS communication device may receive segment data. Segment data may include media data (e.g., content data), as well as error correction data (such as forward error correction (FEC) data) that may enable the MSMS communication device to recover a segment when some media data is lost or corrupted during transmission.

A processor (e.g., the general-purpose processor 206 and/or the baseband modem processor 216) of the MSMS communication device (i.e., a device processor) may also cause the MSMS communication device to perform a tune-away 312 from the first subscription to a second subscription to perform communication operations using the second subscription. For example, at event 310, the device processor may tune an RF resource chain of the MSMS communication device from the first subscription (e.g., SUB1) to the second subscription (e.g., SUB2).

At the end of the tune-away 312, the device processor may tune the RF resource chain of the MSMS communication device (at event 314) from the second subscription (SUB2) to the first subscription (SUB1). After tuning the RF resource chain from the first subscription to the second subscription, the RF resource chain may require a warm-up period 316. During the warm-up period 316, the device processor may receive a pilot signal or reference signal of the first subscription, and may determine information about a data signal of the first subscription, such as channel parameters of the first subscription, which the device processor may use to accurately receive the data signal of the first subscription. In some embodiments, the warm-up period may be approximately 10-30 ms. Following the warm-up period 316, the device processor may resume receiving data 306 over the first subscription.

Typically, tune-aways are periodically scheduled according to a timing dictated by a RAT, and the timing of a tune-away may not be synchronized with the beginning or end of a data burst over the first subscription. For example, in the first scenario the device processor performs the tune-away 312 during the burst 308b, and the warm-up period 316 begins after the beginning of the burst 308c. That is, in the first scenario, the device processor tunes the RF resource chain from the second subscription to the first subscription (event 314) after the beginning of the burst 308c. As another example, in the second scenario the device processor may perform the tune-away 312 during the burst 318a, and the device processor tunes the RF resource chain from the second subscription to the first subscription (event 314) after the burst 318b, and before the beginning of the burst 318c (i.e., the burst 318c may begin during the warm-up period 314).

Data transmitted on the first subscription during the tune-away 312 may not be received, resulting in a data loss 304a. Additionally, during the warm-up period 316, a further amount of data transmitted from the first subscription may not be received, resulting in a further data loss 304b. In combination, the data losses 304a and 304b may have an impact on data throughput to the MSMS communication device over the first subscription, and may reduce or degrade the performance of an application that relies on data received over the first subscription. The problem of data loss during the tune-away 312 and the warm-up period 316 may impact the user experience when the MSMS communication device is conducting communications over the first subscription that are particularly sensitive to latency or data loss, such as streaming audio, video, or other media. To mitigate the data lost during the tune-away 312, the device processor may receive at least some data transmitted over the first subscription during the warmup period 316, thereby reducing the data loss 304b during that time.

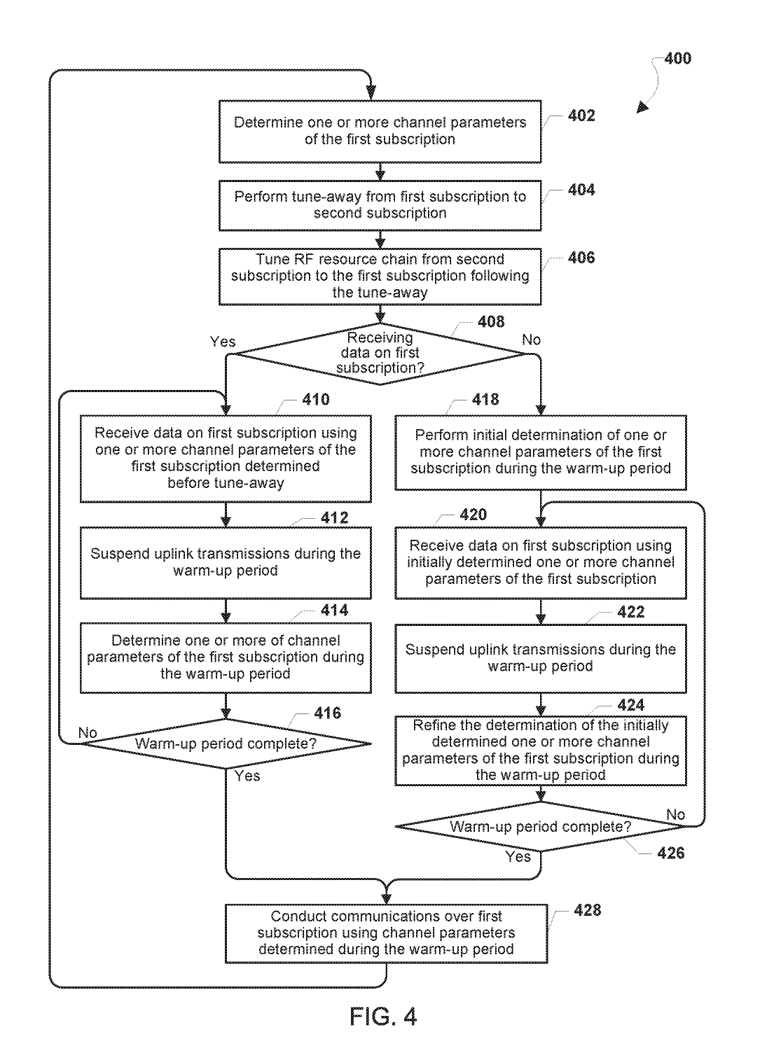

FIG. 4 illustrates a method 400 for managing reception of data using a first subscription following a tune-away by an RF resource chain of an MSMS communication device from the first subscription to a second subscription according to some embodiments. With reference to FIGS. 1-4, the method 400 may be implemented by an MSMS communication device (e.g., the MSMS communication device 110, 200), such as under the control of a processor (e.g., the general-purpose processor 206, the baseband processor 216, a separate controller, and/or the like) of the multi-subscription multi-standby communication device (i.e., a device processor).

In block 402, the device processor may determine one or more channel parameters of the first subscription and store the information in memory. In various embodiments, the channel parameters may include frequency information, timing information, and/or channel estimation information of the first subscription. The channel parameters are information typically used by the MSMS communication device in order to accurately receive a signal (e.g., a data signal) of the first subscription. The channel parameter(s) may change over time, and the device processor may periodically redetermine the channel parameter(s) while receiving data over the first subscription. In some embodiments, the device processor may determine one or more channel parameters of the first subscription in block 402 just prior to a scheduled tune-away in order to obtain and store up to date channel parameters.

In block 404, the device processor may perform a tune-away from the first subscription to the second subscription in which the device processor tunes a shared RF resource chain of the MSMS communication device from the first subscription to the second subscription. During the tune-away, the device processor may perform communication operations over the second subscription. In block 406, the device processor may tune the RF resource chain from the second subscription to the first subscription (i.e., tune back) following the tune-away.

In determination block 408, the device processor may determine whether the device processor is receiving data on the first subscription. Reception of data on the first subscription may depend upon data transmissions by the first network supporting the first subscription. For example, data may be received immediately following a tune-away when the first subscription began sending a data burst during the tune-away (e.g., the tune back occurred during the burst 308c). As another example, the device processor may tune the RF resource chain from the second subscription to the first subscription at the beginning of a data burst on the first subscription (e.g., before the burst 318c). In some embodiments, the device processor may determine whether the device processor has tuned the RF resource chain from the second subscription to the first subscription during a burst (data burst) in determination block 408.

In response to determining that the device processor is receiving data on the first subscription (i.e., determination block 408=“Yes”), in block 410 the device processor may begin receiving data on the first subscription during the warmup period using one or more of the channel parameters of the first subscription that the device processor determined before the tune-away (i.e., in block 402).

In block 412, the device processor may suspend uplink transmissions during the warm-up period to avoid transmitting using channel parameters of the first subscription that were determined before the tune-away, and thus could be stale or otherwise outdated. For example, during the warm-up period the device processor may suspend packet retransmission requests (e.g., Hybrid Automatic Repeat Request (HARQ) non-acknowledgment (NACK) messages), and may not count any lost packet data in a retransmission request mechanism during the warm-up period. Because the one or more channel parameters of the first subscription may change over time, the channel parameter(s) that the device processor determined before the tune-away may be at least partially inaccurate during the warm-up period. The device processor may recognize when this is the case when an error rate (e.g., a block error rate or BLER) received data is relatively high, such as when the processor determines that the error rate meets or exceeds a threshold. In some embodiments, the device processor may receive an error frame or subframe over the first subscription (e.g., a transport block that may include an incorrect cyclic redundancy check). To prevent the MSMS communication device from sending one or more retransmission requests on the first subscription based on outdated channel parameter(s), the device processor may suspend or block the sending of packet retransmission requests during the warm-up period.

As another example, during the warm-up period the device processor may suspend transmission of channel condition reports, such as a Channel Quality Indicator (CQI) or Channel State Information (CSI), as such reports would be based on the relatively inaccurate, older channel parameter(s). As another example, the device processor may suspend transmission of uplink data traffic, because transmitting uplink data using the older channel parameter(s) may cause interference with other mobile communication devices (such as other mobile communication devices communicating with the same communication network, with the same base station/access point, as the MSMS communication device).

In block 414, the device processor may determine one or more of the channel parameters of the first subscription during the warm-up period. In some embodiments, during the warm-up period, the device processor may both receive data on the first subscription using the channel parameters determined before the tune-away and determine more accurate channel parameter(s)

In determination block 416, the device processor may determine whether the warm-up period is complete. In response to determining the warm-up period is not complete (i.e., determination block 416=“No”), in block 410 the device processor may continue to receive data over the first subscription during the warm-up period using the one or more channel parameters of the first subscription that the device processor determined before the tune-away.

In response to determining that the device processor is not receiving data on the first subscription (i.e., determination block 408=“No”), the device processor may perform an initial determination of the one or more channel parameters of the first subscription in block 418. In various embodiments, the channel parameters initially determined during the warm-up period may differ from channel parameters determined by the device processor prior to the tune-away (i.e., at block 402). For example, the one or more channel parameters of the first subscription may vary over time. The initial determination of the one or more channel parameters may include a quick determination in which the device processor may perform less than all (or substantially less than all) of a set of operations that the device processor may perform to determine the one or more channel parameters during the entire duration of the warm-up period.

In block 420, the device processor may use the one or more initially determined channel parameters to receive data over the first subscription during the warm-up period.

In block 422, the device processor may suspend uplink transmissions during the warm-up period to avoid transmitting using channel parameters that may not be complete or accurate. For example, during the warm-up period the device processor may suspend packet retransmission requests, and may not count any lost packet data in a retransmission request mechanism during the warm-up period. As another example, during the warm-up period the device processor may suspend transmission of channel condition reports, as such reports would be based on the relatively inaccurate initially determined channel parameter(s). As another example, the device processor may suspend transmission of uplink data traffic, because transmitting uplink data using the initially determined channel parameter(s) may cause interference with other mobile communication devices.

In block 424, the device processor may refine the determination of the initially determined one or more channel parameters of the first subscription during the warm-up period. In some embodiments, the device processor may use additional information about the signal of the first subscription (e.g., which the device processor may determine from a reference signal, or another signal of the first subscription) to refine the one or more channel parameters of the first subscription. In some embodiments, the device processor may average the additional information over a period of time to refine the one or more channel parameters of the first subscription.

In determination block 426, the device processor may determine whether the warm-up period is complete. In response to determining the warm-up period is not complete (i.e., determination block 426=“No”), the device processor may continue to receive data over the first subscription during the warm-up period using one or more channel parameters of the first subscription that the device processor initially determined during the warm-up period in block 420, while suspending uplink transmissions in block 422 and refining the one or more channel parameters of the first subscription in block 424.

In response to determining that the warm-up period is complete (i.e., determination block 416 =“Yes” or determination block 426=“Yes”), the device processor may conduct communications in block 428, including receiving and transmitting, over the first subscription using the one or more channel parameters of the first subscription that were determined and/or refined during the warm-up period. Conducting communications over the first subscription may include receiving data over the first subscription, such as a data stream or broadcast data stream.

The method 400 may be performed periodically, such as for each tune-away from the first subscription to the second subscription, particularly when the first subscription is engaged in an active communication session, such as receiving a data stream or broadcast data stream.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

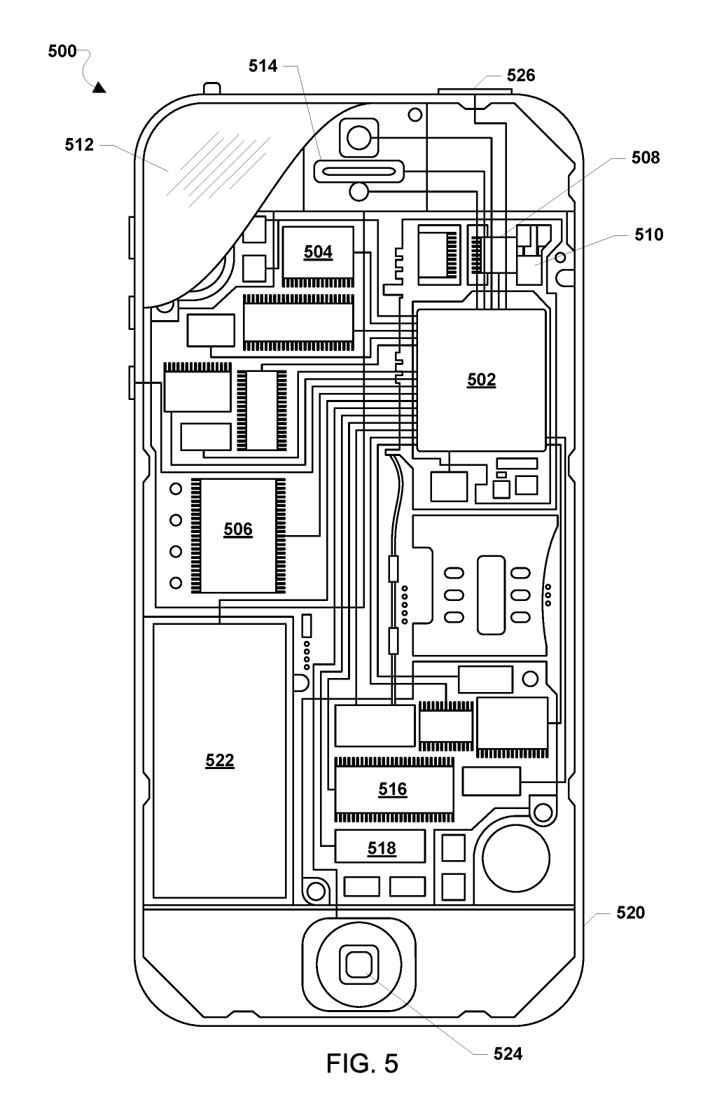

Various embodiments (including, but not limited to, embodiments described with reference to FIGS. 1-4) may be implemented in any of a variety of multi-subscription multi-standby communication devices, an example of which (e.g., multi-subscription multi-standby communication device 500) is illustrated in FIG. 5. With reference to FIGS. 1-5, in various embodiments, the multi-subscription multi-standby communication device 500 (which may correspond, for example, to the multi-subscription multi-standby communication devices 110 and 200) may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the multi-subscription multi-standby communication device 500 need not have touch screen capability.

The multi-subscription multi-standby communication device 500 may have two or more radio signal transceivers 508 (e.g., Peanut, Bluetooth, ZigBee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The multi-subscription multi-standby communication device 500 may include one or more cellular network wireless modem chip(s) 516 coupled to the processor and antennae 510 that enables communication via two or more cellular networks via two or more radio access technologies.

The multi-subscription multi-standby communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The multi-subscription multi-standby communication device 500 may also include speakers 514 for providing audio outputs. The multi-subscription multi-standby communication device 500 may also include a housing 520, constructed of a plastic, metal, or a combination of materials, for containing all or some of the components discussed herein. The multi-subscription multi-standby communication device 500 may include a power source 522 coupled to the processor 502, such as a disposable or rechargeable battery. The rechargeable battery may also be coupled to the peripheral device connection port to receive a charging current from a source external to the multi-subscription multi-standby communication device 500. The multi-subscription multi-standby communication device 500 may also include a physical button 524 for receiving user inputs. The multi-subscription multi-standby communication device 500 may also include a power button 526 for turning the multi-subscription multi-standby communication device 500 on and off

The processor 502 may be any programmable microprocessor, microcomputer or multiple processor chip or chips that can be configured by software instructions (applications) to perform a variety of functions, including the functions of various embodiments described below. In some multi-subscription multi-standby communication devices, multiple processors 502 may be provided, such as one processor dedicated to wireless communication functions and one processor dedicated to running other applications. Typically, software applications may be stored in the internal memory 506 before they are accessed and loaded into the processor 502. The processor 502 may include internal memory sufficient to store the application software instructions.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A method implemented on a multi-subscription multi-standby (MSMS) communication device for managing reception of data on a first subscription following a tune-away of a radio frequency (RF) resource chain from the first subscription to a second subscription, comprising:
receiving data over the first subscription during a warm-up period following tuning of the RF resource chain from the second subscription to the first subscription.

2. The method of claim 1, further comprising:
determining one or more channel parameters of the first subscription before the tune-away from the first subscription to the second subscription,
wherein receiving data over the first subscription during a warm-up period following tuning of the RF resource chain from the second subscription to the first subscription comprises:
determining whether the MSMS communication device is receiving data on the first subscription after tuning the RF resource chain from the second subscription to the first subscription; and
receiving data over the first subscription during the warm-up period using the one or more channel parameters of the first subscription determined before the tune-away from the first subscription to the second subscription in response to determining that the MSMS communication device is receiving data on the first subscription after the tune-away.

3. The method of claim 1, further comprising:
suspending uplink transmissions during the warm-up period.

4. The method of claim 1, further comprising:
determining one or more channel parameters of the first subscription before the tune-away from the first subscription to the second subscription,
wherein receiving data over the first subscription during a warm-up period following tuning of the RF resource chain from the second subscription to the first subscription comprises receiving data over the first subscription during the warm-up period using the one or more channel parameters of the first subscription determined before the tune-away from the first subscription to the second subscription.

5. The method of claim 4, further comprising:
determining one or more channel parameters of the first subscription during the warm-up period;
determining whether the warm-up period is complete;
continuing receiving data over the first subscription during the warm-up period using the one or more channel parameters of the first subscription determined before the tune-away from the first subscription to the second subscription in response to determining that the warm-up period is not complete; and
conducting communications over the first subscription using the one or more channel parameters of the first subscription determined during the warm-up period.

6. The method of claim 1, further comprising:
performing an initial determination of one or more channel parameters of the first subscription during the warm-up period,
wherein receiving data over the first subscription during a warm-up period following tuning of the RF resource chain from the second subscription to the first subscription comprises receiving data over the first subscription during the warm-up period using the initially determined one or more channel parameters of the first subscription.

7. The method of claim 6, further comprising:
determining whether the MSMS communication device is receiving data on the first subscription following the tune-away,
wherein performing the initial determination of one or more channel parameters of the first subscription during the tune-away from the first subscription to the second subscription is performed in response to determining that the MSMS communication device is not receiving data on the first subscription following the tune-away.

8. The method of claim 7, further comprising:
refining the initially determined one or more channel parameters of the first subscription during the warm-up period.

9. The method of claim 8, further comprising:
determining whether the warm-up period is complete;
continuing receiving data over the first subscription during the warm-up period using the initially determined one or more channel parameters of the first subscription in response to determining that the warm-up period is not complete; and
conducting communications over the first subscription using the refined one or more channel parameters of the first subscription in response to determining that the warm-up period is complete.

10. A multi-subscription multi-standby (MSMS) communication device, comprising:
a memory;
a radio frequency (RF) resource chain; and
a processor coupled to the memory and the RF resource chain and configured with processor-executable instructions to:
receive data over a first subscription during a warm-up period following tuning of the RF resource chain from a second subscription to a first subscription after a tune-away from the first subscription to the second subscription.

11. The MSMS communication device of claim 10, wherein the processor is further configured with processor-executable instructions to:
determine one or more channel parameters of the first subscription before the tune-away from the first subscription to the second subscription;
determine whether the MSMS communication device is receiving data on the first subscription after tuning the RF resource chain from the second subscription to the first subscription; and
receive data over the first subscription during the warm-up period using the one or more channel parameters of the first subscription determined before the tune-away from the first subscription to the second subscription in response to determining that the MSMS communication device is receiving data on the first subscription after the tune-away.

12. The MSMS communication device of claim 10, wherein the processor is further configured with processor-executable instructions to:
suspend uplink transmissions during the warm-up period.

13. The MSMS communication device of claim 10, wherein the processor is further configured with processor-executable instructions to:
determine one or more channel parameters of the first subscription before the tune-away from the first subscription to the second subscription; and
receive data over the first subscription during the warm-up period using the one or more channel parameters of the first subscription determined before the tune-away from the first subscription to the second subscription.

14. The MSMS communication device of claim 13, wherein the processor is further configured with processor-executable instructions to:
determine one or more channel parameters of the first subscription during the warm-up period;
determine whether the warm-up period is complete;
continue receiving data over the first subscription during the warm-up period using the one or more channel parameters of the first subscription determined before the tune-away from the first subscription to the second subscription in response to determining that the warm-up period is not complete; and
conduct communications over the first subscription using the one or more channel parameters of the first subscription determined during the warm-up period.

15. The MSMS communication device of claim 10, wherein the processor is further configured with processor-executable instructions to:
perform an initial determination of one or more channel parameters of the first subscription during the warm-up period; and
receive data over the first subscription during the warm-up period using the initially determined one or more channel parameters of the first subscription.

16. The MSMS communication device of claim 15, wherein the processor is further configured with processor-executable instructions to:
determine whether the MSMS communication device is receiving data on the first subscription following the tune-away and
perform the initial determination of one or more channel parameters of the first subscription during the tune-away from the first subscription to the second subscription in response to determining that the MSMS communication device is not receiving data on the first subscription following the tune-away.

17. The MSMS communication device of claim 16, wherein the processor is further configured with processor-executable instructions to:
refine the initially determined one or more channel parameters of the first subscription during the warm-up period.

18. The MSMS communication device of claim 17, wherein the processor is further configured with processor-executable instructions to:
determine whether the warm-up period is complete;
continue receiving data over the first subscription during the warm-up period using the initially determined one or more channel parameters of the first subscription in response to determining that the warm-up period is not complete; and
conduct communications over the first subscription using the refined one or more channel parameters of the first subscription in response to determining that the warm-up period is complete.

19. A multi-subscription multi-standby (MSMS) communication device, comprising:
means for receiving data over a first subscription during a warm-up period following tuning of a radio frequency (RF) resource chain from a second subscription to the first subscription after a tune-away from the first subscription to the second subscription.

20. A non-transitory processor-readable storage medium having stored thereon processor-executable instructions configured to cause a processor of a multi-subscription multi-standby (MSMS) communication device to perform operations comprising:
receiving data over a first subscription during a warm-up period following tuning of a radio frequency (RF) resource chain from a second subscription to the first subscription after a tune-away from the first subscription to the second subscription.

21. The non-transitory processor-readable storage medium of claim 20, wherein the stored processor-executable instructions are configured to cause the processor of the MSMS communication device to perform operations further comprising:
determining one or more channel parameters of the first subscription before the tune-away from the first subscription to the second subscription,
wherein receiving data over the first subscription during a warm-up period following tuning of the RF resource chain from the second subscription to the first subscription comprises:
determining whether the MSMS communication device is receiving data on the first subscription after tuning the RF resource chain from the second subscription to the first subscription; and
receiving data over the first subscription during the warm-up period using the one or more channel parameters of the first subscription determined before the tune-away from the first subscription to the second subscription in response to determining that the MSMS communication device is receiving data on the first subscription after the tune-away.

22. The non-transitory processor-readable storage medium of claim 20, wherein the stored processor-executable instructions are configured to cause the processor of the MSMS communication device to perform operations further comprising:
suspending uplink transmissions during the warm-up period.

23. The non-transitory processor-readable storage medium of claim 20, wherein the stored processor-executable instructions are configured to cause the processor of the MSMS communication device to perform operations further comprising:
determining one or more channel parameters of the first subscription before the tune-away from the first subscription to the second subscription,
wherein receiving data over the first subscription during a warm-up period following tuning of the RF resource chain from the second subscription to the first subscription comprises receiving data over the first subscription during the warm-up period using the one or more channel parameters of the first subscription determined before the tune-away from the first subscription to the second subscription.

24. The non-transitory processor-readable storage medium of claim 23, wherein the stored processor-executable instructions are configured to cause the processor of the MSMS communication device to perform operations further comprising:
determining one or more channel parameters of the first subscription during the warm-up period;
determining whether the warm-up period is complete; and
continuing receiving data over the first subscription during the warm-up period using the one or more channel parameters of the first subscription determined before the tune-away from the first subscription to the second subscription in response to determining that the warm-up period is not complete; and
conducting communications over the first subscription using the one or more channel parameters of the first subscription determined during the warm-up period.

25. The non-transitory processor-readable storage medium of claim 20, wherein the stored processor-executable instructions are configured to cause the processor of the MSMS communication device to perform operations further comprising:
performing an initial determination of one or more channel parameters of the first subscription during the warm-up period,
wherein receiving data over the first subscription during a warm-up period following tuning of the RF resource chain from the second subscription to the first subscription comprises receiving data over the first subscription during the warm-up period using the initially determined one or more channel parameters of the first subscription.

26. The non-transitory processor-readable storage medium of claim 25, wherein the stored processor-executable instructions are configured to cause the processor of the MSMS communication device to perform operations further comprising:
determining whether the MSMS communication device is receiving data on the first subscription following the tune-away,
wherein performing the initial determination of one or more channel parameters of the first subscription during the tune-away from the first subscription to the second subscription is performed in response to determining that the MSMS communication device is not receiving data on the first subscription following the tune-away.

27. The non-transitory processor-readable storage medium of claim 26, wherein the stored processor-executable instructions are configured to cause the processor of the MSMS communication device to perform operations further comprising:
refining the initially determined one or more channel parameters of the first subscription during the warm-up period.

28. The non-transitory processor-readable storage medium of claim 27, wherein the stored processor-executable instructions are configured to cause the processor of the MSMS communication device to perform operations further comprising:
determining whether the warm-up period is complete;
continuing receiving data over the first subscription during the warm-up period using the initially determined one or more channel parameters of the first subscription in response to determining that the warm-up period is not complete; and
conducting communications over the first subscription using the refined one or more channel parameters of the first subscription in response to determining that the warm-up period is complete.
